(19) United States
(12) Patent Application Publication
(10) Pub. No.: US 2023/0275672 A1
(43) Pub. Date: Aug. 31, 2023

(54) ELECTRONIC DEVICE AND METHOD FOR TUNING WAVELENTH IN OPTICAL NETWORK

(71) Applicant: CHEM OPTICS INC, Daejeon-si (KR)

(72) Inventors: Junkyu SEO, Daejeon-si (KR); Yoonkoo KWON, Cheongju-si (KR); Hakkyu LEE, Daejeon-si (KR)

(73) Assignee: CHEM OPTICS INC, Daejeon-si (KR)

(21) Appl. No.: 18/143,788

(22) Filed: May 5, 2023

Related U.S. Application Data
(63) Continuation of application No. PCT/KR2021/011772, filed on Sep. 1, 2021.

(30) Foreign Application Priority Data
Dec. 16, 2020 (KR) 10-2020-0176044

(51) Int. Cl. H04B 10/572; H04B 10/40; H04B 10/50

(52) U.S. Cl. CPC H04B 10/572; H04B 10/40; H04B 10/506

(57) ABSTRACT

An electronic device according to various embodiments performs a channel sweep based on distinct time differences respectively corresponding to supportable channels. An optical signal of the same channel is transmitted at least twice during any one period in which the channel sweep is performed. While the electronic device is performing the channel sweep, an external electronic device receives the optical signal of the same channel at least twice. Based on the time differences between the received optical signals, the external electronic device identifies a channel capable of communicating with the electronic device.

### CROSS-REFERENCE TO RELATED APPLICATION(S)

This application is a continuation application, claiming priority under § 365(c), of PCT International Application No. PCT/KR2021/011772, which was filed on Sep. 1, 2021, and claims priority to Korean Patent Application No. 10-2020-0176044, filed on Dec. 16, 2020, in the Korean Intellectual Property Office, the disclosure of which are incorporated by reference herein their entirety.

### BACKGROUND

### Technical Field

Various embodiments disclosed in this document relate to an electronic device and a method for tuning wavelength in an optical network.

### Description of Related Art

In order to process more data at a higher speed, a proportion of optical communication within a network is increasing. As the proportion of optical communication increases, a demand for an optical transceiver that performs conversion between an electrical signal and an optical signal is increasing.

### SUMMARY

As a demand for an optical transceiver increases, a method for more rapidly installing the optical transceiver within a network may be required.

An electronic device according to various embodiments may comprise an optical transmitter; an optical receiver; and a controller operably coupled to the optical transmitter and the optical receiver, wherein the controller may be configured to control the optical transmitter, based on a first state transmitting at least two optical signals having at least one wavelength among a plurality of wavelengths; identify, after transmitting the at least two optical signals, information for notifying that an external electronic device different from the electronic device receives the at least two optical signals from the optical receiver; and control, in response to the identifying the information, the optical transmitter based on a second state different from the first state.

An electronic device according to various embodiments may comprise an optical transmitter; an optical receiver; and a controller operably coupled to the optical transmitter and the optical receiver, wherein the controller may be configured to receive, by using the optical receiver, at least two optical signals received from an external electronic device different from the electronic device; adjust, in response to receiving the at least two optical signals, wavelength of the optical transmitter based on a timing receiving the at least two optical signals; and control, after adjusting the wavelength of the optical transmitter, the optical transmitter to output an optical signal having the adjusted wavelength to the external electronic device.

A method of an electronic device according to various embodiments may comprise controlling the optical transmitter of the electronic device, based on a first state transmitting at least two optical signals having at least one wavelength among a plurality of wavelengths; identifying, after transmitting the at least two optical signals, information for notifying that an external electronic device different from the electronic device receives the at least two optical signals from the optical receiver; and controlling, in response to the identifying the information, the optical transmitter based on a second state different from the first state.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 is a diagram illustrating a plurality of electronic devices connected to each other based on a network.

FIGS. 2A to 2B are exemplary diagrams for describing a form factor of an electronic device according to some embodiments.

FIG. 3 is a flowchart illustrating an operation of an electronic device according to various embodiments.

FIGS. 4A to 4B are exemplary diagrams for describing one or more wavelengths associated with an electronic device according to various embodiments.

FIGS. 5A to 5B are timing diagrams for describing optical signals transmitted in one or more slots by an electronic device according to various embodiments.

FIG. 6 is a flowchart illustrating an operation of transmitting an optical signal by an electronic device according to an embodiment.

FIG. 7 is a flowchart illustrating an operation of receiving an optical signal by an electronic device according to an embodiment.

FIG. 8 is a timing diagram for describing an optical signal and/or an electrical signal associated with one or more hardware components included in an electronic device according to an embodiment.

FIG. 9 is a timing diagram for describing one or more optical signals transmitted between an electronic device and an external electronic device according to an embodiment.

FIG. 10 is a timing diagram for describing one or more optical signals transmitted between an electronic device and an external electronic device according to another embodiment.

### DETAILED DESCRIPTION

An electronic device and a method according to various embodiments can initiate signal exchange within a network more rapidly.

Specific structural or functional descriptions of the embodiments according to the concept of the present invention disclosed herein are illustrated only for the purpose of describing the embodiments according to the concept of the present invention, and the embodiments according to the concept of the present invention may be implemented in various forms and are not limited to the embodiments described herein.

Since the embodiments according to the concept of the present invention may make various adjustments and may have various forms, the embodiments will be illustrated in the drawings and described in detail herein. However, this is not intended to limit the embodiments according to the concept of the present invention to specific disclosure forms, and includes adjustments, equivalents, or substitutes included in the spirit and technical scope of the present invention.

Although terms such as first or second may be used to describe various components, the components should not be limited by the terms. The terms are used only for the purpose of differentiating one component from another component, for example, without departing from the scope of rights according to the concept of the present invention, a first component may be referred to as a second component, and similarly, the second component may also be referred to as the first component.

When a component is referred to as “connected” or “accessed” to another component, although it may be connected or accessed directly to the other component, it has to be understood that the other component may exist in between. Whereas when a component is referred to as “being directly connected” or “being directly accessed” to another component, it has to be understood that the other component does not exist in between. The phrases describing the relationship between components, such as “between” and “directly between” or “directly adjacent to” have to be interpreted in the same context.

Terms used herein are only used to describe specific embodiments, and are not intended to limit the present invention. Singular expressions include plural expressions unless the context clearly dictates otherwise. In this specification, terms such as “include” or “have” are intended to designate that an embodied feature, number, step, operation, component, part, or combination thereof exists, and have to be understand not to preclude the possibility of the existence or addition of one or more other features, numbers, steps, operations, components, parts, or combinations thereof.

Unless defined otherwise, all terms used herein, including technical or scientific terms, have the same meaning as commonly understood by those having ordinary knowledge in the art to which this invention belongs. Terms such as those defined in commonly used dictionaries have to be interpreted as having consistent meaning with the meaning in the context of the relevant art, and unless clearly defined herein, those are not interpreted as having ideally or excessively formal meanings.

Hereinafter, embodiments will be described in detail with reference to the attached diagrams. However, the scope of the patent claims is not limited or restricted by these embodiments. An identical reference sign presented in each drawing indicate the identical members.

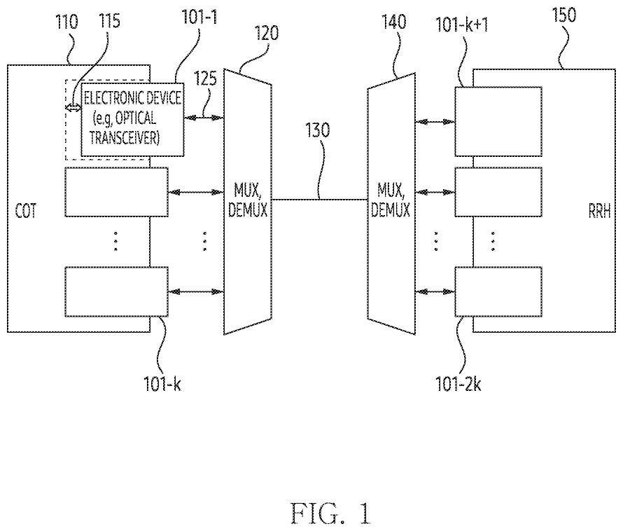

FIG. 1 is a diagram illustrating a plurality of electronic devices connected to each other based on a network. The network of FIG. 1 may include an optical network in which electronic devices disposed in distinct regions are connected based on one or more optical lines 130. The optical network may include a passive optical network (PON).

Referring to FIG. 1, an example in which a central office terminal (COT) 110 and a remote radio head (RRH) 150 included in a network are connected based on the optical line 130 is illustrated. A network including the COT 110 and the RRH 150 may correspond to, for example, at least a portion of a 5G fronthaul. An embodiment for the 5G fronthaul is illustrated, but is not limited thereto, and for example, an optical line terminal (OLT) and/or an optical network unit (ONU) may be connected to each other based on the optical line 130.

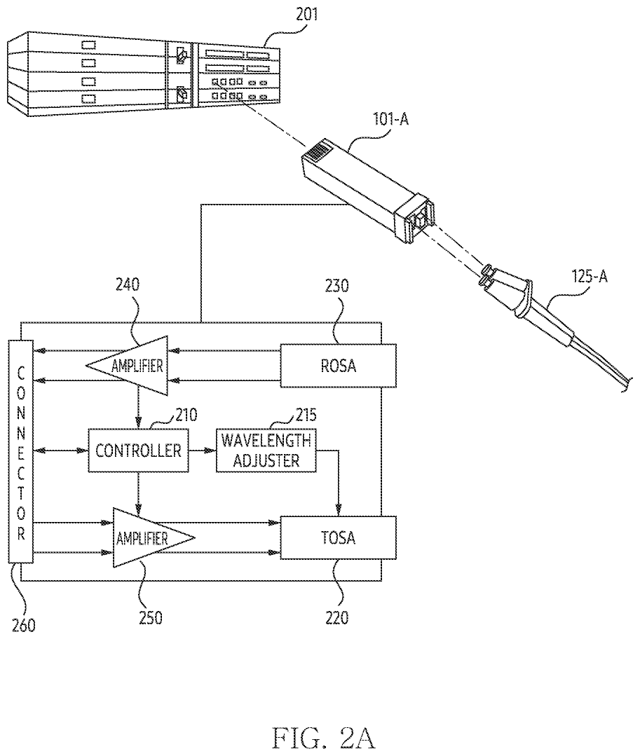

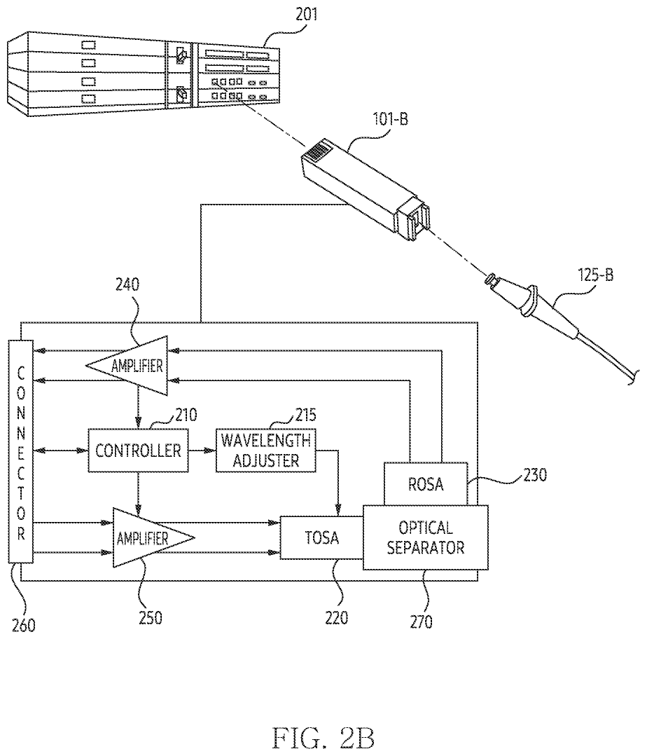

The COT 110 and/or the RRH 150 may include one or more electronic devices according to various embodiments. Referring to FIG. 1, an example in which the COT 110 includes k electronic devices (101-1, . . . , 101-k) according to an embodiment, and the RRH 150 includes k electronic devices (101-k+1, . . . , 101-2k) according to an embodiment is illustrated. Hardware components included in the plurality of electronic devices (101-1, . . . , 101-2k) will be described with reference to FIGS. 2A to 2B.

An electronic device according to an embodiment may correspond to an optical transceiver performing conversion between an optical signal and an electrical signal. Hereinafter, the optical transceiver may be referred to as an electronic device. Hereinafter, an external electronic device may mean an optical transceiver referred to as an electronic device and another optical transceiver connected through an optical network. To perform conversion between the optical signal and the electrical signal, the electronic device according to an embodiment may include an electrical interface 115 to support transmission and/or receiving of the electrical signal and an optical interface 125 to support transmission and/or receiving of the optical signal. The electrical interface 115 may include one or more pins, electrodes, and/or wires transmissible to the electrical signal based on a preset communication protocol, such as, for example, an I2C protocol. The optical interface 125 may include, for example, one or more optical ports for connecting to one or more optical fibers. A form factor of the electronic device connected to the optical interface 125 and the electrical interface 115 will be described in detail with reference to FIG. 2.

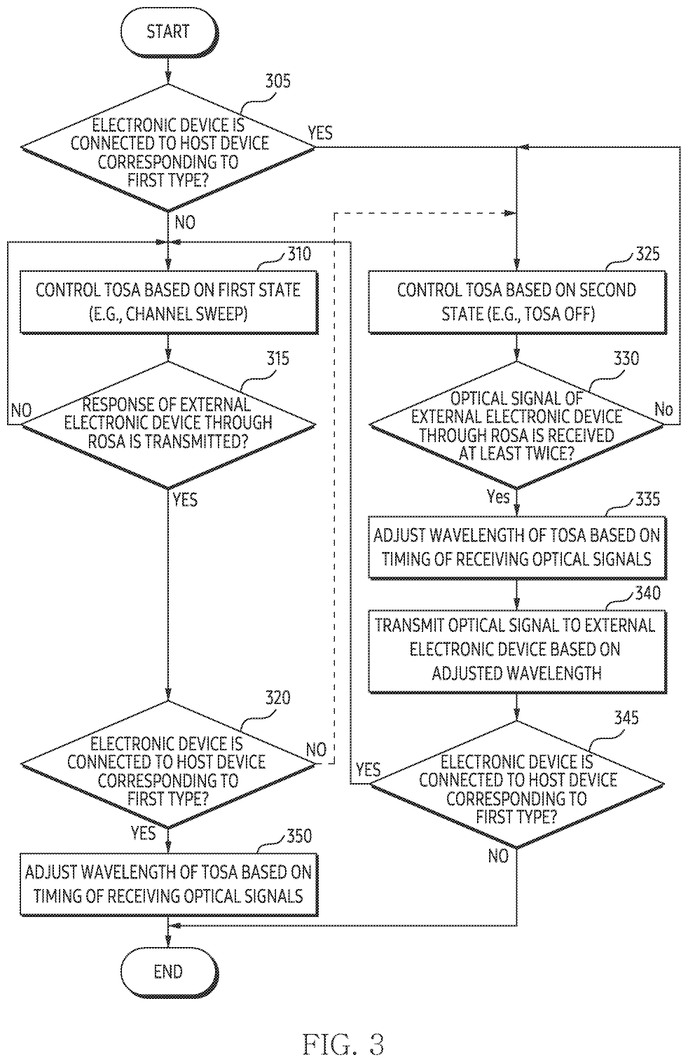

Through the optical interface 125, the electronic device according to an embodiment may be connected to a multiplexer and demultiplexer device (MUX/DEMUX device) 120 included in the optical network. The optical network may include one or more multiplexer and demultiplexer devices 120 and 140. The multiplexer and demultiplexer devices 120 and 140 may perform optical multiplexing and/or demultiplexing based on, for example, an array waveguide grating (AWG). Among optical ports extending from the multiplexer and demultiplexer devices 120 and 140, optical ports connected to the electronic devices (101-1, . . . , 101-2k) may have distinct wavelengths. The electronic devices (101-1, . . . , 101-2k) according to an embodiment may perform the operations of FIGS. 3 to 10 to identify the wavelengths of the optical port provided from the multiplexer and demultiplexer devices 120 and 140.

The multiplexer and demultiplexer devices 120 and 140 may multiplex optical signals having k distinct wavelengths and to output them to the optical line 130, and/or may demultiplex optical signals received from the optical line 130 into optical signals having to up to k distinct wavelengths. The k optical signals which is to be transmitted from the multiplexer and demultiplexer device 120 to the optical line 130, and k optical signals having distinct wavelengths may be outputted ink electronic devices (101-1, . . . , 101-k) included in the COT 110. The k optical signals demultiplexed in the multiplexer and demultiplexer device 120 may be distributed to the k electronic devices (101-1, . . . , 101-k) included in the COT 110.

The multiplexer and demultiplexer devices 120 and 140 may adjust a path through which the optical signal is propagated within the optical network based on a wavelength division multiplexing (WDM). For example, the optical signal in which a plurality of wavelengths are multiplexed through the optical line 130 may be demultiplexed in the multiplexer and demultiplexer device 120 and may be distributed to a plurality of electronic devices (101-1, . . . , 101-k). For another example, a plurality of optical signals having distinct wavelengths transmitted by the plurality of electronic devices (101-1, . . . , 101-k) may be multiplexed in the multiplexer and demultiplexer device 120 and may be propagated along the optical line 130. The multiplexed optical signals may be demultiplexed in the multiplexer and demultiplexer device 140 and may be distributed to a plurality of electronic devices (101-k+1, . . . , 101-2k) included in the RRH 150.

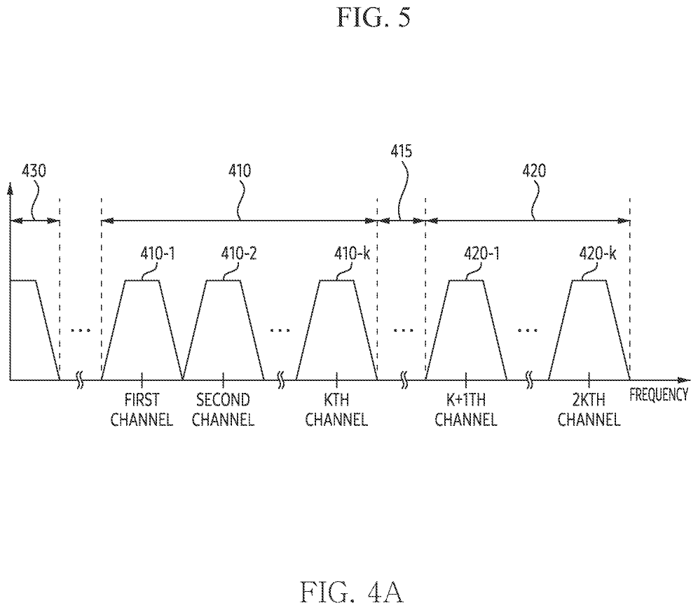

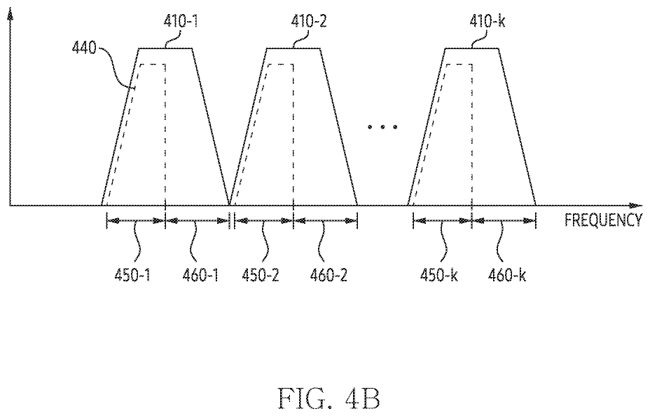

Referring to FIG. 1, as each of the COT 110 and the RRH 150 includes k electronic devices (101-1, . . . , 101-2k), the optical line 130 may transmit optical signals having up to 2×k distinct wavelengths. The 2×k wavelengths transmitted through the optical network will be described in detail with reference to FIGS. 4A to 4B.

The electronic device according to various embodiments may include a tunable optical transceiver. For example, the electronic device may output an optical signal having any one wavelength among a plurality of preset wavelengths. Since the multiplexer and demultiplexer devices 120 and 140 adjust an optical path based on wavelength division multiplexing, only a specific wavelength among the plurality of preset wavelengths may be a transmissible wavelength along the optical network. The electronic device according to an embodiment may identify the specific wavelength independently of the COT 110, the RRH 150, and/or the multiplexer and demultiplexer devices 120 and 140. An operation performed by the electronic device to identify the specific wavelength will be described in detail with reference to FIGS. 3, 5 to 10.

FIGS. 2A to 2B are exemplary diagrams for describing a form factor of electronic devices 101-A and 101-B according to some embodiments. The form factor is an external appearance of an electronic device and may be associated with the structure of an interface (e.g., the electrical interface 115 and the optical interface 125 of FIG. 1) of the electronic device. In an embodiment, the form factor of the electronic devices (101-k+1, . . . , 101-2k) of FIG. 1 is, for example, the form factor based on a small form-factor pluggable (SFP) and may correspond to the form factors of the electronic devices 101-A and 101-B illustrated in FIGS. 2A to 2B. Although the form factor based on SFP is illustrated, the embodiment is not limited thereto, and the electronic device according to another embodiment may have a form factor based on an enhanced SFP (SFP+), a 10 gigabit small form-factor pluggable (XFP), a quad SFP (QSFP), an enhanced QSFP (QSFP+), a C form-factor pluggable (CFP), and a giga bitrate interface converter (GBIC).

Referring to FIGS. 2A to 2B, in an embodiment, the electronic device may be connected to a host device 201 through an electrical interface (e.g., the electrical interface 115 of FIG. 1), and may be connected to optical connectors 125-A and 125-B provided from an optical network through an optical interface (e.g., the optical interface 125 of FIG. 1). The host device 201 is a device connectable to the electronic device through the electrical interface, and may include a COT 110, a RRH 150, an OLT, and an ONU of FIG. 1.

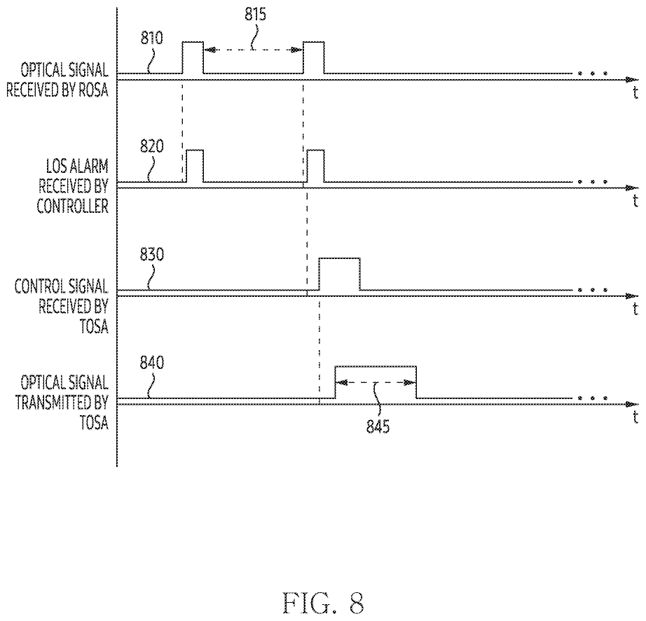

Referring to FIGS. 2A to 2B, according to an embodiment, the electronic device may include a controller 210, a transmitter optical sub-assembly (TOSA) 220, a receiver optical sub-assembly (ROSA) 230, amplifiers 240 and 250, and a connector 260. The controller 210, the TOSA 220, the ROSA 230, the amplifiers 240 and 250, and the connector 260 may be electronically and/or operably coupled with each other by an electronical component such as a communication bus. A type and/or number of hardware components included in the electronic device are not limited to those illustrated in FIGS. 2A to 2B. A Signal transmitted between the controller 210, the TOSA 220, the ROSA 230, and the amplifiers 240 and 250 connected to each other will be described in detail with reference to FIG. 8.

The controller 210 of the electronic device according to an embodiment may include a hardware component for processing data based on one or more instructions. The hardware component for processing data may include, for example, an arithmetic and logic unit (ALU), a field programmable gate array (FPGA), and/or a central processing unit (CPU). The controller 210 may include a microcontroller.

The electronic device according to an embodiment may include a memory for storing data and/or instructions input and/or output to the controller 210. The memory may be included in the controller 210 in a form of a system-on-chip (SoC), or may be disposed on a printed circuit board (PCB) of the electronic device together with the controller 210. The memory may include, for example, a volatile memory such as random-access memory (RAM) and/or a non-volatile memory such as read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multi media card (eMMC).

Within the memory, one or more instructions indicating an operation to be performed on data by the controller 210 may be stored. A set of instructions may be referred to as a firmware, an operating system, a process, a routine, a sub-routine, and/or an application. For example, the electronic device and/or the controller 210 may perform at least one of the operations of FIGS. 3, 6 to 7 by executing a set of a plurality of instructions distributed in the form of the application.

The TOSA 220 of the electronic device according to an embodiment may output an optical signal. The TOSA 220 may include a laser diode (LD) for generating an optical signal. The laser diode may include, for example, a Fabry Perot LD (-FP-LD), a distributed feedback LD (DFB-LD), a distributed Bragg reflector LD (DBR-LD), an external cavity laser (ECL), and/or a vertical cavity surface emitting laser (VCSEL). The laser diode is classified into a directly modulated laser (DML) and an electro-absorption modulated laser (EML) according to a modulation method.

In an embodiment, the laser diode included in the TOSA 220 may include a wavelength tunable laser diode (Tunable LD) that outputs optical signals having distinct wavelengths based on voltage, current, and/or temperature. The electronic device according to an embodiment may include a wavelength adjuster 215 for changing the wavelength of the TOSA 220. In an embodiment, the wavelength adjuster 215 may change the wavelength of the optical signal outputted from the TOSA 220 by adjusting amplitude and/or frequency of the voltage and/or the current inputted to the TOSA 220. In order to adjust the amplitude and/or the frequency of the voltage and/or the current, the wavelength adjuster 215 may include an oscillator and/or a modulator. In another embodiment, the wavelength adjuster 215 may change the wavelength of the optical signal outputted from the TOSA 220 by adjusting the temperature of the TOSA 220. To adjust the temperature, the wavelength adjuster 215 may include a thermistor and/or a thermo-electric cooler (TEC). The wavelength adjuster 215 may be controlled by the controller 210.

In an optical network, a plurality of channels may be defined by dividing the wavelength and/or the frequency along a preset interval (or preset spacing). As the wavelength and/or the frequency of the TOSA 220 is changed, a channel (e.g., a transmission channel) corresponding to the optical signal outputted by the electronic device may be changed. The optical signal outputted by the TOSA 220 may be generated based on an electrical signal (e.g., an electrical signal received from the host device 201) received to the electronic device through the connector 260. Referring to FIGS. 2A to 2B, the electronic device may amplify the electrical signal input to the TOSA 220 by using an amplifier 250 or may block the electrical signal input to the TOSA 220. Hereinafter, the TOSA 220 may be referred to as an optical transmitter.

The ROSA 230 of the electronic device according to an embodiment may receive an optical signal provided from an optical network through the optical connectors 125-A and 125-B. The ROSA 230 may output an electrical signal corresponding to the received optical signal. In order to output the electrical signal, the ROSA 230 may include a photodiode (PD). The PD may include a P-I-N PD (PIN-PD) and an avalanche PD (APD). The ROSA 230 may support receiving the optical signal in a plurality of channels. The electrical signal outputted from the ROSA 230 may be outputted to the connector 260 through an amplifier 240. In case that the connector 260 is connected to a host device 201, an electrical signal outputted from the ROSA 230 may be transmitted to the host device 201 through the connector 260. The amplifier 240 may include a limiting amplifier that changes the magnitude of the electrical signal of the ROSA 230. The amplifier 240 may output information for notifying whether the ROSA 230 has received the optical signal to the controller 210. For example, the information may be included in an electrical signal referred to as a loss-of-signal (LOS) alarm. Hereinafter, the ROSA 230 may be referred to as an optical receiver.

The connector 260 of the electronic device according to an embodiment is an electrical interface (e.g., the electrical interface 115 of FIG. 1) and may support electrical coupling between the electronic device and the host device 201. Referring to FIGS. 2A to 2B, an electrical signal inputted to the connector 260 may pass the amplifier 250 and be transmitted to the TOSA 220 to cause an output of the optical signal. The optical signal inputted to the optical receiver is converted into the electrical signal and then transmitted to the host device 201 through the connector 260, enabling the host device 201 to transmit information. The host device 201 may communicate with the controller 210 through the connector 260 to obtain information associated with the state of the electronic device (e.g., temperature, light output, bias current, supply voltage, and/or receiving sensitivity of the electronic device), and/or may control the operation of the electronic device.

Referring to FIGS. 2A to 2B, electronic devices 101-A and 101-B having an optical interface corresponding to optical connectors 125-A and 125-B of distinct forms are illustrated. The optical connector 125-A may be a duplex LC for connecting a plurality of distinct optical cables to each of the optical transmitter and the optical receiver. The optical connector 125-B may be a simplex LC for connecting the same optical cable to the optical transmitter and the optical receiver. The electronic device connected to the optical connector 125-B may further include an optical separator 270 connected to the optical connector 125-B so that the optical signal outputted from the optical transmitter is transmitted to the optical connector 125-B instead of the optical receiver, and may enable the optical signal propagated from the optical connector 125-B to the optical separator 270 to be transmitted to the optical receiver instead of the optical transmitter. The optical separator 270 may pass and/or reflect one or more preset wavelength ranges and/or frequency bands, by including an etalone filter. For example, the optical separator 270 may include a low pass filter (LPF), a high pass filter (HPF), a band pass filter (BPF), and/or a comb filter. An electronic device further including the optical separator 270 may be referred to as a bi-directional optical sub-assembly (BOSA).

The electronic devices 101-A and 101-B of FIGS. 2A to 2B may change the wavelength of the optical transmitter independently of the control of the host device 201. Without receiving the electrical signal for adjusting the wavelength from the host device 201, the electronic device according to an embodiment may identify a wavelength, frequency, and/or channel capable of communicating with an external electronic device connected through the optical network. The electronic device according to an embodiment may identify the wavelength, frequency, and/or channel capable of communicating with the external electronic device without using a separate channel for communication between optical transceivers, such as, for example, an auxiliary management and control channel (AMCC) and/or an out-of-band (OOB). As the electronic device does not use AMCC and/or OOB, a hardware component for using AMCC and/or OOB may be excluded from the electronic device, and the production cost of the electronic device may be reduced. Hereinafter, referring to FIG. 3, an operation for establishing optical connection with an external electronic device by the electronic devices 101-A and 101-B of FIGS. 2A to 2B without a control signal of the host device 201 will be described.

FIG. 3 is a flowchart illustrating an operation of an electronic device according to various embodiments. The electronic device of FIG. 3 may include electronic devices (101-k+1, . . . , 101-2k) of FIG. 1 and electronic devices 101-A and 101-B of FIGS. 2A to 2B. The operation of FIG. 3 may be performed, for example, by a controller 210 of FIGS. 2A to 2B.

Referring to FIG. 3, in operation 305, the electronic device according to an embodiment may determine whether it is connected to a host device corresponding to a first type. The host device may include, for example, the host device 201 of FIG. 2. The first type of the host device may include, for example, a COT 110 and/or an OLT of FIG. 1. A second type of the host device different from the first type may include, for example, a RRH 150 and/or an ONU of FIG. 1. In an embodiment, the first type and the second type may include information for differentiating distinct host devices allocated in opposite sides of the optical network.

The electronic device according to an embodiment may obtain information indicating the type of the host device from the host device. For example, the host device may transmit information indicating the type of the host device to the electronic device using an electrical signal based on an I2C protocol. The information may be stored in a memory of the electronic device. The electrical signal may include a request signal for storing the information in a preset address of a preset memory. The preset memory may include, for example, an electrically erasable PROM (EEPROM) and/or a virtual memory corresponding to the EEPROM. The preset address may include, for example, a vender-specific area where information preset by a vendor of the host device is stored in the memory. The information indicating the type of the host device may include, for example, at least one of a part number, a part name, and/or a flag indicating whether it corresponds to the first type.

In case that the electronic device is not connected to the host device corresponding to the first type (305—No), in an operation 310, the electronic device according to an embodiment may control an optical transmitter (e.g., TOSA 220 of FIGS. 2A to 2B) based on the first state. For example, in case that the electronic device is connected to a host device corresponding to the second type, the electronic device may perform the operation 310. The first state is a state in which the electronic device outputs an optical signal, and may mean a state in which a plurality of optical signals having each of all supportable channels such as a channel sweep are outputted. For example, in case that the number of channels that the supportable by the electronic device is k, the electronic device may output k optical signals corresponding to each of the k channels n times (n is a natural number exceeding 1) for each preset period.

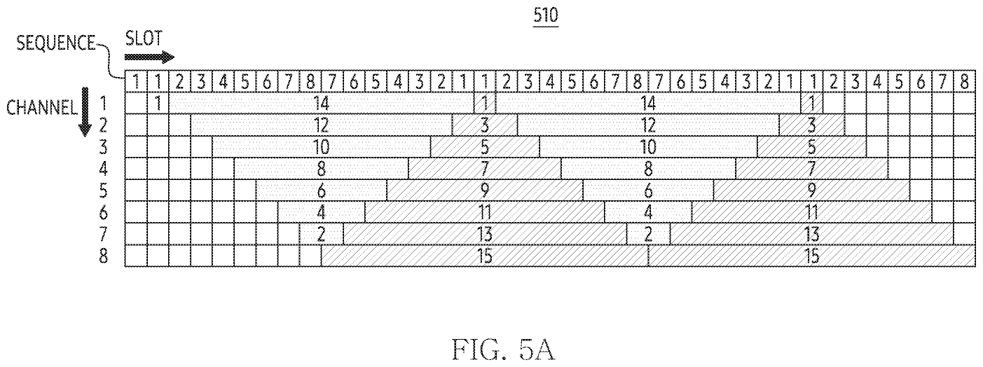

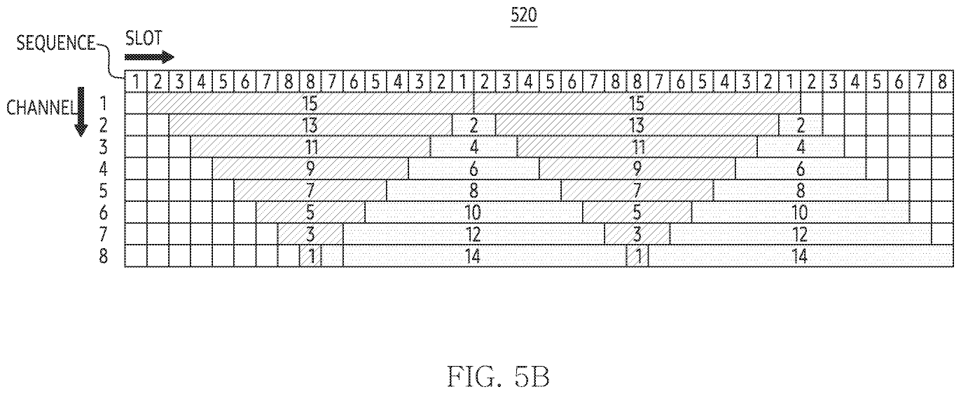

In a state of channel sweeping based on the operation 310, the electronic device according to an embodiment may output the optical signal having a specific wavelength at least twice. In a first state, an interval at which the optical signal having any one wavelength among a plurality of wavelengths is outputted may be different from an interval at which the optical signal having another wavelength among the plurality of wavelengths is outputted. In an embodiment, a time difference between outputting optical signals having the same wavelength may correspond to the wavelengths of the optical signals. An operation in which the electronic device outputs the optical signal in the first state will be described in detail with reference to FIGS. 5A to 5B and FIGS. 9 to 10. Based on the operation 310, some of the outputted optical signals may be transmitted to an external electronic device through the optical network. For example, only an optical signal of a specific channel may be transmitted to the external electronic device through the optical network. In response to receiving the optical signal, the external electronic device may transmit an optical signal notifying the receiving of the optical signal to the electronic device.

In a state in which the optical transmitter is controlled based on the first state, in an operation 315, the electronic device according to an embodiment may determine whether a response of the external electronic device has been transmitted by using an optical receiver (e.g., ROSA 230 of FIGS. 2A to 2B). For example, in response to receiving the optical signal having a preset duration (e.g., 5 seconds), the electronic device may determine that the response has been transmitted. In case that the response is not transmitted (315—No), the electronic device may maintain controlling the optical transmitter based on the operation 310.

In case that the response is transmitted (315—Yes), in an operation 320, the electronic device according to an embodiment may determine whether it is connected to the host device corresponding to the first type. The operation 320 may be performed similarly to an operation 305. In case that the electronic device is not connected to the host device corresponding to the first type (320—No), in an operation 325, the electronic device according to an embodiment may control the optical transmitter based on a second state different from the first state. The second state may mean a state in which the electronic device pauses outputting the optical signal. For example, the electronic device may cease outputting the optical signal by blocking the flow of the electrical signal toward the optical transmitter by using an amplifier 250 of FIGS. 2A to 2B. The second state may mean a state in which the electronic device receives the optical signal by using the optical receiver.

Referring to operations 305, 310, and 325, the electronic device may select a state to enter first among the first state and the second state according to the type of the host device. For example, in case of being connected to a host device corresponding to the first type, such as COT, the electronic device may enter the second state prior the first state based on the operation 325. For another example, in case of being connected to a host device corresponding to the second type, such as RRH, the electronic device may enter the first state prior to the second state based on the operation 310. In distinct types of host devices (e.g., COT 110 and RRH 150 of FIG. 1) allocated in opposite sides of the optical network, one or more electronic devices included in the host device corresponding to the second state may enter the first state, and one or more electronic devices included in the host device corresponding to the first state may enter the second state.

In a state of controlling the optical transmitter based on the second state, in an operation 330, the electronic device according to an embodiment may determine whether the optical signal of the external electronic device has been received at least twice through the optical receiver. While the electronic device does not transmit the optical signal, the external electronic device controlled based on the first state may output the optical signal to the optical network. In this case, the electronic device may receive the optical signal outputted from the external electronic device. In case that the optical signal of the external electronic device is received less than once (330—No), the electronic device may continue to perform the operation 325. For example, the electronic device may maintain ceasing transmission of optical signal until two or more optical signals are received from the external electronic device.

In case that the optical signal of the external electronic device is received at least twice (330—Yes), in an operation 335, the electronic device according to an embodiment may adjust a wavelength of the optical transmitter based on a timing receiving the optical signals. In case that the external electronic device operates based on the operation 310, an interval of the optical signals received in the second state of the operation 325 may correspond to the wavelength of the optical signals. For example, optical signals received by the electronic device may have distinct intervals for each wavelength by channel sweep. The electronic device according to an embodiment may identify a wavelength corresponding to the interval in which at least two optical signals are received. Based on the identified wavelength, the electronic device may change the wavelength of the optical transmitter. The wavelength of the optical transmitter that the electronic device according to an embodiment changes based on the operation 335 is a wavelength based on the wavelength of the optical signal received in the operation 330, and may be, for example, a wavelength transmissible to the external electronic device.

In an operation 340, the electronic device according to an embodiment may transmit the optical signal to the external electronic device based on the adjusted wavelength. For example, the electronic device may transmit the optical signal for a preset duration. Since the electronic device changes the wavelength of the optical transmitter to a wavelength transmissible to the external electronic device based on the operation 335, the optical signal transmitted in the operation 340 may be transmitted to the external electronic device.

After transmitting the optical signal in the operation 340, in an operation 345, the electronic device may determine whether the electronic device is connected to a host device corresponding to the first type. In case that the electronic device is not connected to the host device corresponding to the first type (345—No), the electronic device may maintain controlling the optical transmitter based on the adjusted wavelength in the operation 335. In case that the electronic device is connected to the host device corresponding to the first type (345—Yes), the electronic device may perform a channel sweep by entering the first state of the operation 310.

The operation 345 may be performed similarly to at least one of the operations 305 and 320. Referring to FIG. 3, by performing the operations 305, 320, and 345, the electronic device according to an embodiment may determine a sequence of entering the first state and the second state based on the type of the host device. For example, in case of being connected to the host device corresponding to the first type such as COT (305—Yes, 345—Yes, 320—Yes), the electronic device may control the optical transmitter based on the second state, and then enter the first state to perform the channel sweep. In this case, in an operation 350 after the channel sweep, similarly to the operation 335, the electronic device may adjust the wavelength of the optical transmitter based on the timing at which the optical signals are received in the operation 330. For another example, in case of being connected to the host device corresponding to the second type such as RRH (305—No, 320—No, 345—No), the electronic device may perform the channel sweep based on the first state, and then enter the second state to select the wavelength of the optical transmitter. Since the sequence in which the electronic device enters the first state and the second state varies depending on the type of the host device, electronic devices connected to distinct types of host devices may perform cross channel sweeps within the optical network. Hereinafter, referring to FIGS. 4A to 4B, a wavelength adjusted by an electronic device according to an embodiment will be described.

FIGS. 4A to 4B are exemplary diagrams for describing one or more wavelengths associated with an electronic device according to various embodiments. The electronic device according to various embodiments may operate by selecting any one of a plurality of channels defined for distinct wavelength range and/or frequency band. The electronic device may select a channel by using, for example, a wavelength adjuster 215 of FIGS. 2A to 2B.

Referring to FIGS. 4A to 4B, a plurality of channels (410-1, 410-2, . . . , 410-k, 420-1, . . . , 420-k) preset by an optical network to which the electronic device is connected are illustrated. Each of the plurality of channels (410-1, 410-2, . . . , 410-k, 420-1, . . . , 420-k) may have a distinct center wavelength and/or center frequency. Each of the plurality of channels (410-1, 410-2, . . . , 410-k, 420-1, . . . , 420-k) may have the same wavelength range and/or frequency band, and may correspond to a frequency band of 100 GHz, for example, based on an ITU-T wavelength grid.

Referring to FIG. 4A, the optical network connected to the electronic device according to an embodiment may have a downstream channel group 410 and an upstream channel group 420 separated by a channel spacing 415. K channels (410-1, 410-2, . . . , 410-k) included in the downstream channel group 410 may be used to generate an optical signal propagating in a direction which faces toward a subscriber (e.g., a direction which faces from the COT 110 to the RRH 150 of FIG. 1). The k channels (420-1, 420-2, . . . , 420-k) included in the upstream channel group 420 may be used to generate an optical signal propagating in another direction (e.g., a direction which faces from the RRH 150 to the COT 110 of FIG. 1) different from the above direction. A size of the channel spacing 415 may be, for example, less than or equal to 100 GHz. In some embodiments, the size of the channel spacing 415 may be 0 Hz.

Each of the channels of the upstream channel group 410 may make a pair with each of the channels of the downstream channel group 420. For example, a first channel 410-1 of the upstream channel group 410 may make a pair with a k+1th channel 420-1 of the downstream channel group 420. The channel of the upstream channel group 410 and the channel of the downstream channel group 420 that make a pair may be used to establish optical communication between an electronic device and an external electronic device connected in opposite sides of the optical network. For example, based on an operation of FIG. 3, the electronic device receiving the optical signal included in the first channel 410-1 may transmit a response notifying the receiving of the optical signal by using an optical signal included in the k+1th channel 420-1 which makes pair with the first channel 410-1. The pair of the above-described upstream channel and downstream channel may be preset by a multiplexer and demultiplexer disposed in the optical network.

Referring to FIG. 4A, a low frequency band 430 different from the upstream channel group 410 and the downstream channel group 420 may be preset as an AMCC. The AMCC may be used to transmit information for changing wavelength of the electronic device and the external electronic device within the optical network. The electronic device according to an embodiment may change the wavelength based on an interval of the optical signal without using the AMCC. As the electronic device does not use the AMCC, the electronic device may operate without a circuit for supporting communication based on the AMCC.

FIG. 4B is a diagram for describing another example of the channel used in the optical network connected to the electronic device. Referring to FIG. 4B, each of the plurality of channels (410-1, 410-2, . . . , 410-k) may be a channel having a size of 100 GHz based on an ITU-T wavelength grid. The electronic device according to an embodiment may transmit an optical signal based on sub-channels having a lower frequency band in each of the plurality of channels (410-1, 410-2, . . . , 410-k). Referring to FIG. 4B, each of the plurality of channels (410-1, 410-2, . . . , 410-k) may have two sub-channels having a size of less than 100 GHz. The upstream channel and the downstream channel may be differentiated in a sequence of the sub-channel based on the frequency within the channel. For example, the sub-channels (450-1, 450-2, . . . , 450-k) having a relatively low frequency band in each of the plurality of channels (410-1, 410-2, . . . , 410-k) may correspond to the upstream channel group. In this case, the sub-channels (460-1, 460-2, . . . , 460-k) having a relatively high frequency band in each of the plurality of channels (410-1, 410-2, . . . , 410-k) may correspond to the downstream channel group. In this case, since the number of selectable frequencies increases in a frequency band of the same size, the capacity of the optical network may be increased. In an embodiment in which each of the plurality of channels (410-1, 410-2, . . . , 410-k) is differentiated into two sub-channels, two sub-channels included in the same channel may be set as a pair of the upstream channel and the downstream channel. Hereinafter, referring to FIGS. 5A to 5B, an operation of performing a channel sweep in the channels of FIGS. 4A to 4B by an electronic device according to an embodiment will be described.

FIGS. 5A to 5B are timing diagrams 510 and 520 for describing an optical signal transmitted in one or more slots by an electronic device according to various embodiments. In FIGS. 5A to 5B, an example in which an electronic device identifies a channel transmittable to an external electronic device among eight channels will be described. According to embodiments, the number of channels supportable by the electronic device is not limited to the example of FIGS. 5A to 5B. The electronic device according to an embodiment may output an optical signal having different wavelengths according to a sequence illustrated in FIGS. 5A to 5B, for example, based on an operation 310 of FIG. 3. A slot may have a size of few milliseconds as a unit of a preset time section.

Referring to FIGS. 5A to 5B, a horizontal axis may correspond to time, and a vertical axis may correspond to a channel. Referring to a sequence of a timing diagram 510 of FIG. 5A, the electronic device according to an embodiment may continuously transmit the optical signal of a first channel having the lowest frequency among the eight channels twice in a preset sequence, and then transmit the optical signal by increasing the frequency as the slot elapses. After transmitting the optical signal of an eighth channel having the highest frequency among the eight channels, the electronic device may transmit the optical signal by decreasing the frequency as the slot elapses. Accordingly, for every period of 15 slots, the electronic device may use each of the eight channels at least twice.

Referring to FIG. 5A, intervals of optical signals in each of the eight channels are illustrated. Referring to the first channel among the eight channels, while the electronic device continuously transmits the optical signal of the first channel twice, the optical signal of the first channel may be outputted from the electronic device every 1 slot and 14 slots. For another example, an optical signal of a second channel may be outputted from the electronic device every 12 slots and 3 slots, and an optical signal of a third channel may be outputted from the electronic device every 10 slots and 5 slots. Referring to the timing diagram 510 of FIG. 5A, the interval of optical signals may vary according to channels.

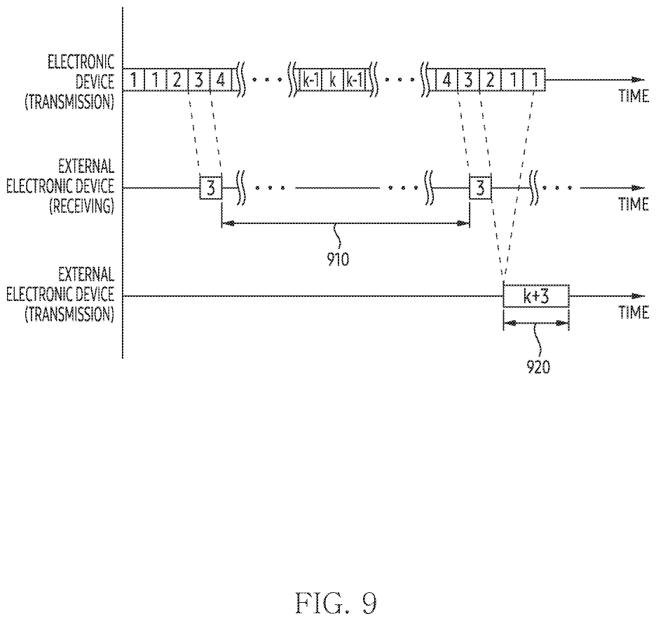

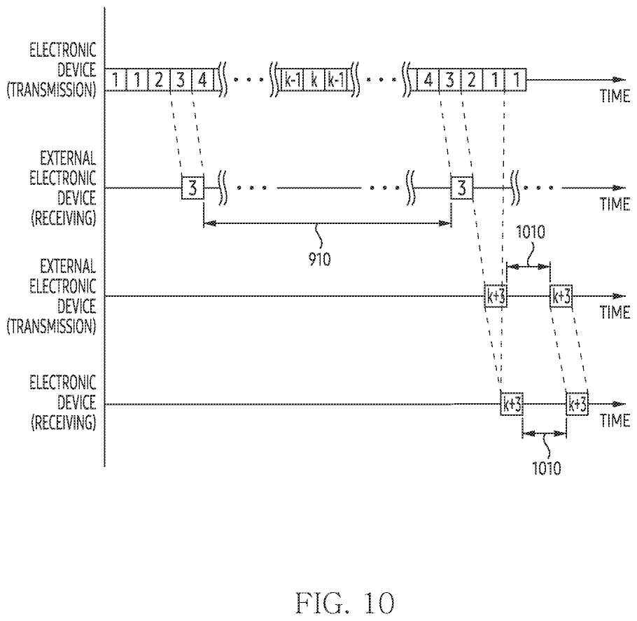

Since the interval of the optical signals is different for each channel, an external electronic device receiving the optical signal may identify the channel of the optical signal by using the interval of the received optical signal. Without measuring a wavelength and/or frequency of the received optical signal by using an optical receiver (e.g., ROSA 230 of FIGS. 2A to 2B), the electronic device according to an embodiment may identify the channel of the optical signal. For example, the optical signals received at every 8 slots interval may be optical signals of a fourth channel, and the optical signals received at every 9 slots interval may be optical signals of a fifth channel. Since an upstream channel and a downstream channel make a pair, in response to the identification of the channel of the received optical signal, the external electronic device may transmit a response based on the channel identified to the electronic device. An operation in which an electronic device and an external electronic device exchange optical signals will be described in detail with reference to FIGS. 9 to 10.

A sequence in which the electronic device changes channels is not limited to the sequence of the timing diagram 510 of FIG. 5A, and may have a distinct sequence for outputting optical signals at distinct intervals for each channel. In another embodiment, the electronic device may change the channel according to a timing diagram 520 of FIG. 5B. Referring to the sequence of the timing diagram 520 of FIG. 5B, the electronic device according to an embodiment may sequentially transmit optical signals while increasing the frequency from the first channel having the lowest frequency among the eight channels in a preset sequence. In the eighth channel having the highest frequency among the eight channels, the electronic device may continuously transmit the optical signal having the eighth channel twice. After continuously transmitting the optical signal having the eighth channel twice, the electronic device may transmit the optical signal by decreasing the frequency as the slot elapses.

Referring to FIG. 5B, during a first time section within a preset period, the electronic device may control the optical transmitter so that a plurality of optical signals having each of a plurality of channels are outputted from the optical transmitter based on a preset first sequence. The first time section may correspond to a time section in which the electronic device transmits the optical signal while increasing the frequency from the first channel having the lowest frequency among the eight channels. During a second time section different from the first time section within the preset period, the optical transmitter may be controlled so that the plurality of optical signals having each of the plurality of channels are outputted based on a second sequence different from the first sequence. The second time section may correspond to a time section in which the electronic device transmits the optical signal while decreasing the frequency from the eighth channel having the highest frequency among the eight channels. For example, the first sequence may be a reverse order of the second sequence, and a sequence of wavelengths of the plurality of optical signals outputted from the optical transmitter during the first time section may be in reverse order regarding the sequence of wavelengths of the plurality of optical signals outputted from the optical transmitter during the second time section.

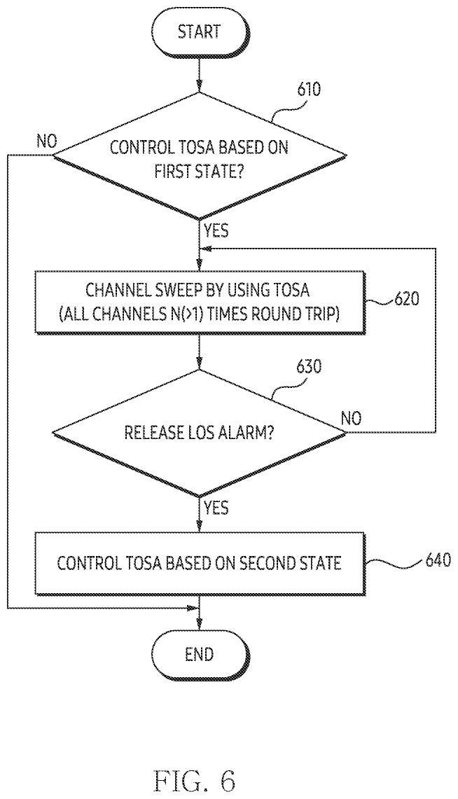

Referring to FIGS. 5A to 5B, a first time difference and/or a slot interval in which two optical signals of any one of the plurality of channels are output may be different from a time difference and/or a slot interval in which two optical signals of the other channel of the plurality of channels are outputted. Hereinafter, referring to FIG. 6, an operation of performing a channel sweep by the electronic device based on the sequence of FIGS. 5A to 5B will be described.

FIG. 6 is a flowchart illustrating an operation of transmitting an optical signal by an electronic device according to an embodiment. The operation of FIG. 6 may be performed, for example, by a controller 210 of FIGS. 2A to 2B. The operation of FIG. 6 may be based, for example, at least on operations 310 and 315 of FIG. 3.

Referring to FIG. 6, in an operation 610, an electronic device according to an embodiment may determine whether to control an optical transmitter based on a first state. The first state may include the first state of the operation 310 of FIG. 3. The first state may mean, for example, a state before identifying a transmissible wavelength through an optical network. In case that the transmissible wavelength is identified through the optical network, the electronic device may not control the optical transmitter based on the first state (610—No).

In a case of controlling the optical transmitter based on the first state (610—Yes), in an operation 620, the electronic device according to an embodiment may perform a channel sweep by using the optical transmitter. The electronic device according to an embodiment may control the optical transmitter based on the first state of transmitting at least two optical signals having any one wavelength of a plurality of wavelengths. While performing the channel sweep, the electronic device may transmit a plurality of optical signals having intervals differentiated according to wavelengths. The electronic device according to an embodiment may transmit the optical signal while adjusting the wavelength in a preset sequence of FIGS. 5A to 5B.

The channel sweep may be repeatedly performed every preset period. In the first state, a controller (e.g., the controller 210 of FIGS. 2A to 2B) of the electronic device according to an embodiment may transmit, in a first slot among a plurality of slots included in a preset period, a first signal for transmitting a first optical signal having a first wavelength among the plurality of wavelengths to the optical transmitter to a wavelength adjuster (e.g., the wavelength adjuster 215 of FIGS. 2A to 2B) and/or an optical transmitter (e.g., the TOSA 220 of FIGS. 2A to 2B). In a second slot adjacent to the first slot among the plurality of slots, the controller may transmit a second signal for transmitting a second optical signal having a second wavelength different from the first wavelength among the plurality of wavelengths to the wavelength adjuster and/or the optical transmitter. In a third slot after the second slot, the controller may transmit the first signal for re-transmitting the first optical signal having the first wavelength to the wavelength adjuster and/or the optical transmitter. In a fourth slot after the second slot, which is different from the third slot, the controller may transmit the second signal for re-transmitting the second optical signal having the second wavelength to the wavelength adjuster and/or the optical transmitter. In an embodiment, a time difference between the first slot and the third slot in which the first optical signal having the first wavelength is transmitted by the first signal may be distinct from a time difference between the second slot and the fourth slot in which the second optical signal having the second wavelength is transmitted by the second signal.

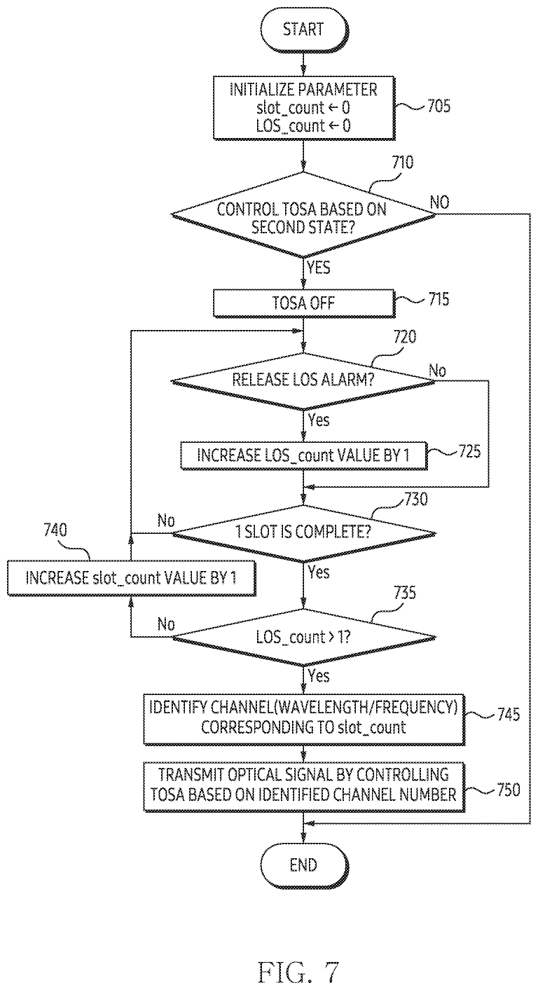

In a state of performing the channel sweep, in an operation 630, the electronic device according to an embodiment may identify release of a LOS alarm. The LOS alarm may be generated in a state in which an optical receiver (e.g., the ROSA 230 of FIGS. 2A to 2B) does not receive an optical signal. The release of the LOS alarm may be at least based on the optical signal received by the electronic device from an external electronic device. For example, in response to receiving at least two optical signals based on the channel sweep of the operation 620, the external electronic device may transmit the optical signal to the electronic device. The optical signal transmitted by the external electronic device to the electronic device may transmit, for example, by the external electronic device by performing at least one of the operations of FIG. 7. In response to receiving the optical signal from the external electronic device, the LOS alarm may be released. The optical receiver according to an embodiment may release the LOS alarm in order to indicate information for notifying that the external electronic device different from the electronic device receives the at least two optical signals from the optical receiver. The LOS alarm may correspond to a preset signal outputted from an amplifier (e.g., the amplifier 240 of FIGS. 2A to 2B) that adjusts the size of an electrical signal outputted from the optical receiver.

In case that the LOS alarm is not released (630—No), the electronic device may maintain performing the channel sweep based on the operation 620. In case that the LOS alarm is released (630—Yes), in an operation 640, the electronic device according to an embodiment may control the optical transmitter based on a second state different from a first state of the operation 610. In the second state, the electronic device may cease performing the channel sweep based on the first state. For example, the electronic device may cease transmitting at least two optical signals having a specific wavelength. In the second state, the electronic device may receive at least two optical signals from the external electronic device by using the optical receiver. Hereinafter, referring to FIG. 7, an operation of performing by the electronic device in the second state will be described in detail.

FIG. 7 is a flowchart illustrating an operation of receiving an optical signal by an electronic device according to an embodiment. The operation of FIG. 7 may be performed, for example, by a controller 210 of FIGS. 2A to 2B. The operation of FIG. 7 may be based, for example, at least on operations 325, 330, 335, and 340 of FIG. 3 and/or an operation 640 of FIG. 6.

Referring to FIG. 7, in an operation 705, an electronic device according to an embodiment may initialize at least one parameter stored in a memory. For example, the electronic device may initialize a parameter for counting the number of times an optical signal is received from an external electronic device and a parameter for counting an interval at which a plurality of optical signals receives from the external electronic device. Referring to FIG. 7, in order to count the number of times the optical signal is received from the external electronic device, the electronic device may initialize a parameter (LOS_count) storing the number of times an LOS alarm is released. In order to count the interval between the optical signals received from the external electronic device, the electronic device may initialize a parameter (slot count) storing the number of times of slots. An initialization is to initialize a cell of a memory corresponding to the parameter, and may include an operation of inputting 0 into the cell.

After initialization, in an operation 710, the electronic device according to an embodiment may determine whether to control an optical transmitter based on a second state. The second state may include a second state of an operation 325 of FIG. 3. The second state may mean, for example, a state before receiving the optical signal from the external electronic device connected through an optical network.

In a case of controlling the optical transmitter based on the second state (710—Yes), in an operation 715, the electronic device according to an embodiment may cease the operation of the optical transmitter. In the operation 715, the electronic device may cease outputting the optical signal by using the optical transmitter.

Referring to FIG. 7, in an operation 720, the electronic device according to an embodiment may identify release of an LOS alarm at least based on an optical receiver. In a state in which the operation of the optical transmitter is ceased, the external electronic device may transmit the optical signal to the electronic device based on the operations 310 and 315 of FIG. 6 and/or FIG. 3. The electronic device may receive the optical signal from the external electronic device by using the optical receiver. In response to receiving the optical signal, the LOS alarm transmitted from the optical receiver to a controller may be released.

In case that the LOS alarm is released (720—Yes), in an operation 725, the electronic device according to an embodiment may increase a value of the parameter (LOS_count) associated with the number of times the LOS alarm is released by 1. In case that the LOS alarm is not released (720—No), the electronic device may not perform the operation 725. Referring to FIG. 7, in an operation 730, the electronic device according to an embodiment may identify completion of a single slot. In case that the single slot is not completed (730—No), the electronic device may identify release of the LOS alarm based on the operation 720. Within the single slot, the electronic device may detect a change in the LOS alarm.

In case that the single slot is completed (730—Yes), in an operation 735, the electronic device according to an embodiment may determine whether the LOS alarm has been released a plurality of times. For example, the electronic device may determine whether the parameter (LOS_count) storing the number of times the LOS alarm is released is increased by 1. In case that the LOS alarm is not released the plurality of times (735—No), that is, in case that the parameter is less than or equal to 1, in an operation 740, the electronic device according to an embodiment may increase the value of the parameter (slot count) associated with the number of times of the slots by 1.

Referring to FIG. 7, the operations 720, 725, 730, 735, and 740 may be repeatedly performed until the LOS alarm is released the plurality of times. Until the LOS alarm is released for the first time, none of the initialized parameters may be increased. After the LOS alarm is released for the first time, whenever each slot is completed, the parameter (slot_count) storing the number of times of slots may be increased by 1.

In case that the LOS alarm is released the plurality of times (735—Yes), in an operation 745, the electronic device according to an embodiment may identify a channel corresponding to the number of times of completed slots while the LOS alarm is released the plurality of times. Referring to FIGS. 5A to 5B, the number of times of increased slots while the LOS alarm is released the plurality of times may be a time difference that received optical signals and a number corresponding to a wavelength of the optical signals. Since an upstream channel and a downstream channel make a pair, the electronic device may identify a wavelength, frequency, and/or channel of the optical signal to be transmitted to the external electronic device in correspondence to the identified channel.

Referring to FIG. 7, in an operation 750, the electronic device according to an embodiment may transmit the optical signal to the external electronic device by controlling an optical transmitter based on the identified channel. In response to receiving at least two optical signals from the external electronic device, the electronic device may change the wavelength of the optical transmitter based on the timing at which the at least two optical signals are received. After changing the wavelength of the optical transmitter, the electronic device may control the optical transmitter to output the optical signal having the changed wavelength to the external electronic device.

Hereinafter, as an electronic device receives at least two optical signals in a second state of FIG. 7, signals generated inside the electronic device will be described.

FIG. 8 is a timing diagram for describing an optical signal and/or an electrical signal associated with one or more hardware components included in an electronic device according to an embodiment. In the timing diagram of FIG. 8, the electronic device may be related to at least one of the operations 325, 330, 335, and 340 of FIG. 3 and/or the operations of FIG. 7.

Referring to FIG. 8, an example of an intensity of an optical signal propagating to an optical receiver (e.g., the ROSA 230 of FIGS. 2A to 2B) of an electronic device according to an embodiment is illustrated as a graph 810. The optical signal propagated to the optical receiver may be generated by an external electronic device and may be included in a channel capable of passing through an optical network. The external electronic device may generate the optical signal by performing, for example, at least one of the operations 310 of FIG. 3 and/or the operations of FIG. 6. The external electronic device may perform a channel sweep based on a sequence of FIG. 5A or 5B, for example. Referring to the graph 810, the electronic device may receive an optical signal having a duration time corresponding to a single slot at least twice. The time difference 815 between the twice received optical signals may be associated with a wavelength of the received optical signal.

Referring to FIG. 8, an example of an electrical signal provided from the optical receiver of the electronic device to a controller (e.g., the controller 210 of FIGS. 2A to 2B) while receiving the optical signal having an intensity of graph 810 is illustrated as a graph 820. The electrical signal transmitted from the optical receiver to the controller may be based on, for example, a LOS alarm. The LOS alarm may be changed in response to receiving the optical signal of the optical receiver. For example, in response to receiving the optical signal, the LOS alarm may be released. Referring to FIG. 8, as two optical signals propagate to the optical receiver, the LOS alarm may be released twice. The interval at which the LOS alarm is released may correspond to the time difference 815 between the twice received optical signals.

Referring to FIG. 8, while identifying the LOS alarm corresponding to the graph 820, an example of an electrical signal provided from the controller of the electronic device to an optical transmitter (e.g., the TOSA 220 of FIGS. 2A to 2B) is illustrated as a graph 830. As described in FIGS. 3, 6 to 7, the electronic device may cease an operation of the optical transmitter until at least two optical signals are received. Referring to the graph 830, a signal controlling the optical transmitter may be generated in response to receiving a second optical signal after a first optical signal. The signal is a wavelength at least based on the time difference 815, and may be a control signal for adjusting the wavelength of the optical transmitter.

Referring to FIG. 8, an example of an intensity of an optical signal outputted from the optical transmitter of the electronic device is illustrated as a graph 840. An operation of the electronic device outputting the optical signal in response to receiving an optical signal corresponding to the graph 810 may be performed, for example, based on the operation 340 of FIG. 3 and/or the operation 750 of FIG. 7. A wavelength of the optical signal outputted by the electronic device may be based on a control signal provided to the optical transmitter based on the graph 830. The duration of the optical signal outputted by the electronic device may be at least based on the time difference 815. Referring to the graphs 810, 820, 830, and 840, there may be some delay from the timing of receiving the optical signal to the timing of transmitting the optical signal. Since the electronic device identifies a channel of the optical signal by using the time difference 815, the electronic device may operate independently of AMCC and/or OOB. Alternatively, the electronic device may transmit other information different from information for notifying successful reception of the optical signals, such as LOS alarms, through AMCC and/or OOB.

FIG. 9 is a timing diagram for describing one or more optical signals transmitted between an electronic device and an external electronic device according to an embodiment. The electronic device and the external electronic device of FIG. 9 may correspond to each of optical transceivers connected in opposite sides of an optical network.

Referring to FIG. 9, the electronic device may perform a channel sweep based on, for example, the operation 310 of FIG. 3 and/or the operation of FIG. 6. In case that the number of supportable channels is k, the electronic device may transmit an optical signal while changing a channel from a first channel to a k-th channel among the k channels. Referring to FIG. 9, the electronic device may transmit the optical signal corresponding to the first channel twice, and then may transmit the optical signal while increasing the channel. After increasing up to the k-th channel, the electronic device may transmit the optical signal while decreasing the channel.

By the optical network, only an optical signal of a specific channel among the optical signals of distinct channels transmitted by the electronic device may be propagated to an external electronic device. Referring to FIG. 9, an example in which an optical signal of a third channel among k channels is propagated to an external electronic device is illustrated. Since the electronic device has transmitted an optical signal of any one channel of the k supportable channels at least twice based on the channel sweep, the external electronic device may receive the optical signal of the third channel at least twice. Referring to FIG. 9, the external electronic device may identify a time difference 910 at which optical signals of the third channel are received, for example, based on the operation of FIG. 7. Based on the time difference 910, the external electronic device may identify that the channel of the optical signal is the third channel.

As described in FIGS. 5A to 5B, a channel in a direction which the electronic device faces toward the external electronic device and a channel in a direction which the external electronic device faces toward the electronic device may make a pair each other. Since it is identified that the optical signal corresponding to the third channel has been received, the external electronic device may transmit an optical signal of another channel (e.g., a k+3th channel) corresponding to the third channel. The other channel may be a channel transmissible to the electronic device. The duration 920 of the optical signal transmitted to the other channel may be greater than or equal to the duration of a single slot.

In response to receiving the optical signal from the external electronic device, the electronic device may cease the channel sweep. In case that the electronic device does not receive the optical signal from the external electronic device before the channel sweep, the electronic device may perform at least one operation to respond to the channel sweep of the external electronic device based on the operation 325 of FIG. 3 and/or the operation of FIG. 7. After transmitting the optical signal having the duration 920, the external electronic device may cease responding to the channel sweep of the electronic device. In case that no optical signal is received from the electronic device before at least two optical signals based on the time difference 910, the external electronic device may initiate the channel sweep based on the operation 310 of FIG. 3 and/or the operation of FIG. 6.

FIG. 10 is a timing diagram for describing one or more optical signals transmitted between an electronic device and an external electronic device according to another embodiment. The electronic device and the external electronic device of FIG. 10 may correspond to each of optical transceivers connected in opposite of an optical network. In the description of FIG. 10, an operation similar to that of FIG. 9 is omitted.

Referring to FIG. 10, an example in which an optical signal of a third channel among k channels is propagated from an electronic device to an external electronic device is illustrated. The external electronic device may identify that the optical signals are included in the third channel by using the time difference 910 in which the optical signals are received. In response to receiving at least two optical signals, the electronic device according to an embodiment may transmit optical signals at least based on a channel of the received optical signals at every time difference at least based on a time difference of the received optical signals. Referring to FIG. 10, the external electronic device may transmit an optical signal of a k+3th channel that makes a pair with the third channel to the electronic device every time difference 1010 corresponding to the k+3th channel. Since the k+3th channel is a channel transmissible from the external electronic device to the electronic device, the electronic device may receive two optical signals with a time difference 1010. Based on the time difference 1010, the electronic device may identify that the received optical signals are included in the k+3th channel. In this case, the external electronic device may transmit at least two optical signals based on the time difference 1010 to the electronic device while maintaining the k+3th channel without a channel sweep.

Although only an embodiment in which the channel sweep is performed alternately has been described above, the channel sweep may be performed simultaneously. The electronic device and the external electronic device according to an embodiment may simultaneously perform the channel sweep. In this case, in response to receiving at least two optical signals, the electronic device and the external electronic device may substantially simultaneously select a channel at least based on the time difference of the received optical signals.

In an embodiment, AMCC and/or OOB may be used to notify a period of the channel sweep. For example, the electronic device may notify the external electronic device of information associated with the period of the channel sweep and/or the duration of a single slot through the AMCC and/or the OOB. The external electronic device may identify a channel corresponding to the time difference 910 based on the information.

The electronic device according to various embodiments may perform the channel sweep based on distinct time differences corresponding to each of the supportable channels. An optical signal of the same channel may be transmitted at least twice during any one period in which the channel sweep is performed. While the electronic device performs the channel sweep, the external electronic device may receive the optical signal of the same channel at least twice. Based on the time difference of the received optical signals, the external electronic device may identify the channel capable of communicating with the electronic device.

An electronic device according to various embodiments may comprise an optical transmitter; an optical receiver; and a controller operably coupled to the optical transmitter and the optical receiver, wherein the controller may be configured to control the optical transmitter, based on a first state transmitting at least two optical signals having at least one wavelength among a plurality of wavelengths; identify, after transmitting the at least two optical signals, information for notifying that an external electronic device different from the electronic device receives the at least two optical signals from the optical receiver; and control, in response to the identifying the information, the optical transmitter based on a second state different from the first state.

A controller according to an embodiment, in the first state may be configured to control, during a first time section in a preset period, the optical transmitter that a plurality of optical signals respectively having the plurality of wavelengths are outputted from the optical transmitter based on a preset first sequence; control, during a second time section different from the first time section in the preset period, the optical signal that a plurality of optical signals respectively having a plurality of wavelengths are outputted based on a second sequence different from the first sequence.

In the electronic device according to an embodiment, the plurality of optical signals may be outputted from the optical transmitter during the second time section and in reverse order regarding a sequence of wavelengths of the plurality of optical signals outputted from the optical transmitter during the first time section, according to the second sequence which is a reverse order of the first sequence.

A controller according to an embodiment, in the first state, may be configured to transmit, in a first slot of a plurality of slots repeated by a preset period, a first signal for transmitting a first optical signal having a first wavelength among the plurality of wavelengths to the optical transmitter; transmit, in a second slot adjacent to the first slot of the plurality of slots, a second signal for transmitting a second optical signal having a second wavelength different from the first wavelength of the plurality of wavelengths to the optical transmitter; transmit, in a third slot after the second slot of the plurality of slots, the first signal for re-transmitting the first optical signal having the first wavelength to the optical transmitter; transmit, in a fourth slot after the second slot of the plurality of slots, the second signal for re-transmitting the second optical signal having the second wavelength to the optical transmitter; and wherein the time difference between the first slot and the third slot may be different from a time difference between the second slot and the fourth slot.

According to an embodiment, in the first state, from an optical transmitter of an electronic device wherein at least two optical signals having a first wavelength among the plurality of wavelengths may be outputted per a first time difference; and wherein at least two different optical signals having a second wavelength different from the first wavelength among the plurality of wavelengths may be outputted per a second time difference different from the first time difference.

An electronic device according to an embodiment, may further comprise an amplifier configured to adjust a size of an electronic signal outputted from the optical receiver, and wherein the controller may be configured to control to identify the information based on a preset signal outputted from the amplifier.

A controller according to an embodiment, in the second state, may be configured to cease transmitting the at least two optical signals; receive, by using the optical receiver, the at least two optical signals from the external electronic device; control, in response to receiving the at least two optical signals, the optical transmitter to output an optical signal having wavelength at least based on the received at least two optical signal among the plurality of wavelengths during a preset time.

A controller according to an embodiment, in the second state, may be configured to identify, in response to receiving the at least two optical signals, a time difference of the received at least two optical signals; control the optical transmitter to output the optical signal having the wavelength associated with the identified time difference among the plurality of wavelengths.

An electronic device according to various embodiments may comprise an optical transmitter, an optical receiver, and a controller operably coupled to the optical transmitter and the optical receiver, wherein the controller may be configured to receive, by using the optical receiver, at least two optical signals received from an external electronic device different from the electronic device; adjust, in response to receiving the at least two optical signals, wavelength of the optical transmitter based on a timing receiving the at least two optical signals; control, after adjusting the wavelength of the optical transmitter, the optical transmitter to output an optical signal having the adjusted wavelength to the external electronic device.

In an electronic device according to an embodiment, the controller may be configured to identify a time difference receiving the at least two optical signals; adjust, in response to identifying the time difference, wavelength of the optical transmitter to wavelength corresponding to the identified time difference among the plurality of wavelengths.

An electronic device according to an embodiment may further comprise an amplifier which adjusts a size of an electronic signal outputted from the optical receiver; wherein the controller may control to identify information associated with a timing receiving the at least two optical signals based on Loss-of-Signal (LOS) alarm identified from the amplifier.

In an electronic device according to an embodiment, the controller may be configured to control, before receiving the at least two optical signals, the optical transmitter based on a second state different from a preset first state enabling outputting an optical signal; control, in response to receiving the at least two optical signals, the optical transmitter based on the first state.

In an electronic device according to an embodiment, the controller may be configured to identify, another external electronic device different from the external electronic device connected through an wired interface to the electronic device; identify, in response to identifying the other external electronic device, information associated with a type of the other external electronic device from the other external electronic device; initiate, in response to identifying the information corresponding to a preset type, controlling the optical transmitter based on the second state.

In an electronic device according to an embodiment, the controller may be configured to control, in the first state, the optical transmitter to output at least two optical signals having one wavelength of a plurality of wavelengths; identify, after outputting the at least two optical signals, information for notifying that the external electronic device receives the outputted at least two optical signals from the optical receiver; control, in response to identifying the information, the optical transmitter based on wavelength corresponding to the information among the plurality of wavelengths.

In an electronic device according to an embodiment, the controller may control the optical transmitter to output at least two optical signals having a preset time difference corresponding to the adjusted wavelength.

A method of an electronic device according to various embodiments may comprise controlling, the optical transmitter of the electronic device, based on a first state transmitting at least two optical signals having at least one wavelength among a plurality of wavelengths; identifying, after transmitting the at least two optical signals, information for notifying that an external electronic device different from the electronic device receives the at least two optical signals from the optical receiver; and controlling, in response to the identifying the information, the optical transmitter based on a second state different from the first state.

In an embodiment, an operation of controlling based on the first state may further comprise controlling, during a first time section in a preset period, the optical transmitter that a plurality of optical signals respectively having a plurality of wavelengths are outputted form the optical transmitter based on a preset first sequence; and controlling, during a second time section different from the first time section in the preset period, the optical transmitter that a plurality of optical signals having a plurality of wavelengths are outputted based on a second sequence different from the first sequence.

In an embodiment, an operation of controlling based on the first state may further comprise outputting, at least two optical signals having a first wavelength among the plurality of wavelengths per a first time difference; and outputting, at least two different optical signals having a second wavelength different from the first wavelength among the plurality of wavelengths per a second time difference different from the first time difference.

In an embodiment, an operation identifying the information may further comprise identifying the information based on a preset signal outputted from an amplifier which adjusts a size of an electronic signal outputted from the optical receiver.

In an embodiment, an operation controlling the optical transmitter based on the second state may further comprise ceasing, transmitting the at least two optical signals based on the first state; receiving, by using the optical receiver, the at least two optical signals from the external electronic device; and controlling, in response to receiving the at least two optical signals, the optical transmitter to output an optical signal having wavelength at least based on the received at least two optical signals among the plurality of wavelengths during a preset time.

A method of an electronic device according to an embodiment may comprise receiving, by using an optical receiver included in the electronic device, at least two optical signals received from an external electronic device different from the electronic device; adjusting, in response to receiving the at least two optical signals, wavelength of an optical transmitter included in the electronic device based on a timing receiving the at least two optical signals; and controlling, after adjusting the wavelength of the optical transmitter, the optical transmitter to output an optical signal having the adjusted wavelength to the external electronic device.

In an embodiment, an operation adjusting the wavelength of the optical transmitter may further comprise identifying, a time difference receiving the at least two optical signals; and adjusting, in response to identifying the time difference, wavelength of the optical transmitter to wavelength corresponding to the identified time difference among the plurality of wavelengths.

In an embodiment, an operation receiving the at least two optical signals may further comprise identifying, based on Loss-of-Signal (LOS) alarm identified from an amplifier which adjusts a size of an electronic signal outputted from the optical receiver and is included in the electronic device, information associated with a timing receiving the at least two optical signals.

A method of an electronic device according to an embodiment may further comprise controlling, before receiving the at least two optical signals, the optical transmitter based on a second state different from a preset first state enabling outputting an optical signal; and controlling, in response to receiving the at least two optical signals, the optical transmitter based on the first state.

In an embodiment, an operation controlling the optical transmitter based on the second state may further comprise identifying, another external electronic device different from the external electronic device connected through an wired interface to the electronic device; identifying, in response to identifying the other external electronic device, information associated with a type of the other external electronic device from the other external electronic device; and initiating, in response to identifying the information corresponding to a preset type, controlling the optical transmitter based on the second state.

A method of an electronic device according to an embodiment may further comprise controlling, in the first state, the optical transmitter to output at least two optical signals having one wavelength of a plurality of wavelengths; identifying, after outputting the at least two optical signals, information for notifying that the external electronic device receives the outputted at least two optical signals from the optical receiver; and controlling, in response to identifying the information, the optical transmitter based on wavelength corresponding to the information among the plurality of wavelengths.

The controlling the optical transmitter according to an embodiment may further comprise controlling the optical transmitter to output at least two optical signals having a preset time difference corresponding to the adjusted wavelength.

The device described above may be implemented as the hardware component, the software component, and/or the combination of the hardware component and the software component. For example, the device and component described in the embodiments, may be implemented by using one or more general purpose or special purpose computers such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding the instructions. The processing device may execute an operating system (OS) and one or more software applications executed on the operating system. Also, the processing device may access, store, manipulate, process, and generate data in response to an execution of the software. For convenience of understanding, there are cases in which only one processing device is described as being used, but those having ordinary knowledge in the art will recognize that a processing device may include a plurality of processing elements and/or a plurality types of processing elements. For example, the processing device may include a plurality of processors or one processor and one controller. And another processing configuration is also possible, such as parallel processor.

Software may include a computer program, a code, an instruction, or a combination of one or more thereof, and may configure a processing device to operate as desired or may independently or collectively direct a processing device. Software and/or data may be permanently or temporarily embodied in some tangible machine, component, physical device, virtual equipment, computer storage medium or device, or transmitted signal wave, to be interpreted by a processing device or to provide instructions or data to a processing device. Software may be distributed on networked computer systems and stored or executed in a distributed method. Software and data may be stored in one or more computer readable recording medium.

A method according to an embodiment may be implemented in a form of program instruction that may be executed through various computer means and recorded in a computer readable medium. The computer readable medium may include a program instruction, a data file, a data structure, and the like alone or in combination. The program instruction recorded on the medium may be specially designed and configured for the embodiment or may be known and usable to those having ordinary knowledge in computer software. Examples of computer readable recording medium include magnetic media such as hard disk, floppy disk, and magnetic tape, optical media such as CD-ROM and DVD, magneto-optical media such as floptical disk, and hardware device specifically configured to store and execute program instruction such as ROM, RAM, flash memory, and the like. Examples of program instruction include advanced language codes that may be executed by a computer by using an interpreter, as well as machine language codes such as those produced by a compiler. The hardware device described above may be configured to operate as one or more software modules to perform an operation of an embodiment, and vice versa.

As described above, although the embodiments have been described with reference to the limited embodiments and diagrams, various modifications and variations are capable from the above description by those having ordinary knowledge in the art. For example, an appropriate result may achieve even when the described techniques are performed in an order different from the described methods, and/or the components such as the described system, structure, device, circuit and the like are coupled or combined in a form different from the described method, or are substituted or replaced by other components or equivalents.

Therefore, other implementations, other embodiments, and scope and equivalents of patent claims are also within the scope of the following patent claims.

This invention was supported by Korea Evaluation Institute of Industrial Technology, and under the ATC (Advanced Technology Center)+R&D program named the polymer-based waveguide hybrid 50 Gbps wavelength-tunable laser development project, where the program is carried out from May 1, 2020 to Jun. 30, 2024.

What is claimed is:

1. An electronic device, comprising:
an optical transmitter;
an optical receiver; and
a controller operably coupled to the optical transmitter and the optical receiver,
wherein the controller is configured to:
control the optical transmitter, based on a first state transmitting at least two optical signals having at least one wavelength among a plurality of wavelengths;
identify, after transmitting the at least two optical signals, information for notifying that an external electronic device different from the electronic device receives the at least two optical signals from the optical receiver; and
control, in response to the identifying the information, the optical transmitter based on a second state different from the first state.

2. The electronic device of claim 1, wherein the controller in the first state is configured to:
control, during a first time section in a preset period, the optical transmitter that a plurality of optical signals respectively having a plurality of wavelengths are outputted from the optical transmitter based on a preset first sequence;
control, during a second time section different from the first time section in the preset period, the optical transmitter that a plurality of optical signals respectively having a plurality of wavelengths are outputted based on a second sequence different from the first sequence.

3. The electronic device of claim 2, wherein the plurality of optical signals are outputted from the optical transmitter during the second time section and in reverse order regarding a sequence of wavelengths of the plurality of optical signals outputted from the optical transmitter during the first time section, according to the second sequence which is a reverse order of the first sequence.

4. The electronic device of claim 1, wherein the controller in the first state is configured to:
transmit, in a first slot of a plurality of slots repeated by a preset period, a first signal for transmitting a first optical signal having a first wavelength among the plurality of wavelengths to the optical transmitter;
transmit, in a second slot adjacent to the first slot of the plurality of slots, a second signal for transmitting a second optical signal having a second wavelength different from the first wavelength of the plurality of wavelengths to the optical transmitter;
transmit, in a third slot after the second slot of the plurality of slots, the first signal for re-transmitting the first optical signal having the first wavelength to the optical transmitter;
transmit, in a fourth slot after the second slot of the plurality of slots, the signal for re-transmitting the second optical signal having the second wavelength to the optical transmitter; and
wherein a time difference between the first slot and the third slot is different from a time difference between the second slot and the fourth slot.

5. The electronic device of claim 1, wherein at least two optical signals having a first wavelength among the plurality of wavelengths are outputted per a first time difference; and wherein at least two other optical signals having a second wavelength different from the first wavelength among the plurality of wavelengths are outputted per a second time difference different from the first time difference.

6. The electronic device of claim 1, further comprising an amplifier configured to adjust a size of an electronic signal outputted from the optical receiver, and wherein the controller is configured to control to identify the information based on a preset signal outputted from the amplifier.

7. The electronic device of claim 1, wherein the controller in the second state is configured to:
cease transmitting the at least two optical signals;
receive, by using the optical receiver, the at least two optical signals from the external electronic device; and
control, in response to receiving the at least two optical signals, the optical transmitter to output an optical signal having wavelength at least based on the received at least two optical signal among the plurality of wavelengths during a preset time.

8. The electronic device of claim 7, wherein the controller in the second state is configured to:
identify, in response to receiving the at least two optical signals, a time difference of the received at least two optical signals;
control the optical transmitter to output the optical signal having the wavelength associated with the identified time difference among the plurality of wavelengths.

9. A method of an electronic device, comprising:
receiving, by using an optical receiver included in the electronic device, at least two optical signals received from an external electronic device different from the electronic device;
adjusting, in response to receiving the at least two optical signals, wavelength of an optical transmitter included in the electronic device based on a timing receiving the at least two optical signals; and
controlling, after adjusting the wavelength of the optical transmitter, the optical transmitter to output an optical signal having the adjusted wavelength to the external electronic device.

10. The method of claim 9, wherein the adjusting the wavelength of the optical transmitter comprises:
identifying a time difference receiving the at least two optical signals; and
adjusting, in response to identifying the time difference, wavelength of the optical transmitter to wavelength corresponding to the identified time difference among the plurality of wavelengths.

11. The method of claim 9, wherein the receiving the at least two optical signals comprising:
identifying, based on Loss-of-Signal (LOS) alarm identified from an amplifier which adjusts a size of an electronic signal outputted from the optical receiver and is included in the electronic device, information associated with a timing receiving the at least two optical signals.

12. The method of claim 9, further comprising:
controlling, before receiving the at least two optical signals, the optical transmitter based on a second state different from a preset first state enabling outputting an optical signal; and
controlling, in response to receiving the at least two optical signals, the optical transmitter based on the first state.

13. The method of claim 12, wherein the controlling the optical transmitter based on the second state further comprises:
identifying another external electronic device different from the external electronic device connected through an wired interface to the electronic device;
identifying, in response to identifying the other external electronic device, information associated with a type of the other external electronic device from the other external electronic device; and
initiating, in response to identifying the information corresponding to a preset type, controlling the optical transmitter based on the second state.

14. The method of claim 12, further comprising:
controlling, in the first state, the optical transmitter to output at least two optical signals having one wavelength of a plurality of wavelengths;
identifying, after outputting the at least two optical signals, information for notifying that the external electronic device receives the outputted at least two optical signals from the optical receiver; and
controlling, in response to identifying the information, the optical transmitter based on wavelength corresponding to the information among the plurality of wavelengths.

15. The method of claim 9, wherein the controlling the optical transmitter further comprises:
controlling the optical transmitter to output at least two optical signals having a preset time difference corresponding to the adjusted wavelength.
